(19) United States
(12) Patent Application Publication
(10) Pub. No.: US 2025/0176571 A1
(43) Pub. Date: Jun. 5, 2025

(54) FRESH FOOD PRESERVATION EQUIPMENT

(71) Applicant: INNOVATION CENTER OF YANGTZE RIVER DELTA ZJU, Jiaxing (CN)

(72) Inventors: Tian DING, Jiaxing (CN); Xinyu LIAO, Jiaxing (CN); Hu SHI, Jiaxing (CN); Xingyu CHEN, Jiaxing (CN)

(21) Appl. No.: 18/435,543

(22) Filed: Feb. 7, 2024

(30) Foreign Application Priority Data
Dec. 5, 2023 (CN) 2023116634330

(51) Int. Cl. A23L 3/26; A23L 3/37

(52) U.S. Cl. CPC A23B 2/503; A23B 2/85

(57) ABSTRACT

A fresh food preservation equipment is provided, includes a preservation box formed with a cavity therein, an atomization device configured for outputting water mist to the plasma activated droplet generating device, a plasma activated droplet generating device configured for ionizing the water mist output from the atomization device and feeding a resultant activated mist into the cavity, a refrigeration device configured for reducing temperature inside the cavity, a sensing system includes an oxygen sensor, a humidity sensor, and a temperature sensor for monitoring oxygen concentration, temperature and humidity in the cavity, respectively, and a control unit. Compared with the prior art, the fresh food preservation equipment in the present disclosure achieves the effects of keeping moisture and reducing the respiration intensity of fruits and vegetables while keeping fresh, and the quality of fresh food is effectively ensured, so that the shelf life is prolonged.

### CROSS-REFERENCE TO RELATED APPLICATIONS

This patent application claims the benefit and priority of Chinese Patent Application No. 202311663433.0 filed with the China National Intellectual Property Administration on Dec. 5, 2023, the disclosure of which is incorporated by reference herein in its entirety as part of the present application.

### TECHNICAL FIELD

The present disclosure relates to the technical field of food preservation, in particular to a fresh food preservation equipment.

### BACKGROUND

Fresh food is one type of the most basic consumer goods. With people's increasing emphasis on dietary health, the scale of domestic fresh food market is increasing year by year. However, fresh food is highly perishable at room temperature, and is easily damaged due to extrusion during transportation.

At present, low temperature, modified atmosphere/vacuum, ice temperature and so on are commonly used fresh preservation technologies. However, there is a problem of poor preservation effect when conventional physical low-temperature technologies such as ice bags are used, resulting in frequent occurrences of “pseudo-cold chain” incidents. In addition, the cost of gas used in modified atmosphere/vacuum preservation technology is high, and vacuum preservation technology is not suitable for soft fresh food, such as strawberries and peaches. Furthermore, high precision of temperature control is required for ice temperature preservation, and it is required to ensure temperature fluctuation in ice temperature storages is small. Therefore, it is urgent to develop technologies to effectively solve the “pain points” of the fresh food industry with high decay rate.

### SUMMARY

The purpose of the present disclosure is to provide a fresh food preservation equipment. The equipment achieves the effects of keeping moisture and reducing the respiration intensity of fruits and vegetables while keeping fresh, and the quality of fresh food is effectively ensured, so that the shelf life is prolonged.

In order to achieve the purpose, the present disclosure provides the following solution.

Disclosed is a fresh food preservation equipment, including:
a preservation box formed with a cavity therein;
an atomization device mounted on the preservation box for outputting water mist;
a plasma activated droplet generation device mounted on the preservation box for ionizing the water mist output from the atomization device and feeding a resultant activated mist into the cavity;
a refrigeration device mounted on the preservation box for reducing temperature inside the cavity;
a sensing system including an oxygen sensor, a humidity sensor, and a temperature sensor for monitoring oxygen concentration, temperature, and humidity in the cavity, respectively; and
a control unit electrically connected with the atomization device, the plasma activated droplet generation device, the refrigeration device, and the sensing system, respectively, for controlling operation of the plasma activated droplet generation device according to oxygen concentration information returned by the oxygen sensor, controlling operation of the atomization device according to humidity information returned by the humidity sensor, and controlling operation of the refrigeration device according to temperature information returned by the temperature sensor.

Preferably, the plasma activated droplet generation device comprises a first insulating cover, second insulating covers, metal electrodes, silicone elbows, and wires. The first insulating cover is sleeved outside the second insulating covers to form water mist flow channels between the first insulating cover and the second insulating covers. The metal electrodes are arranged inside the second insulating covers, and the metal electrodes are electrically connected with the wires, The wires are connected to a power supply, and the wires pass through the silicone elbows. The silicone elbows are fixed on the second insulating covers. Multiple second insulating covers are arranged in the first insulating cover, so that the metal electrodes in adjacent second insulating covers are capable of discharging with each other, and the water mist in the water mist flow channels is ionized, resulting in the activated mist. The first insulating cover communicates with the atomization device, an air outlet is formed in the first insulating cover, and the second insulating covers are arranged in a sealed manner.

Preferably, both the first insulating cover and the second insulating covers are in a cylindrical shape; and taking an axis of the first insulating cover as a center of the plasma activated droplet generation device, multiple second insulating covers are arranged along a circumferential direction of the plasma activated droplet generation device without interval.

Preferably, the metal electrodes are in a cylindrical shape and are concentrically arranged with the second insulating covers.

Preferably, a PVC (polyvinyl chloride) tube is provided as the first insulating cover, and quartz glass tubes are provided as the second insulating covers. A nylon tube is arranged on an inner side of the multiple second insulating covers that are arranged along the circumferential direction of the plasma activated droplet generation device without interval. The nylon tube is concentrically arranged with the first insulating cover, and the nylon tube is fixedly connected with the first insulating cover through a connector. The second insulating covers are sandwiched between an outer side of the nylon tube and an inner side of the first insulating cover.

Preferably, the atomization device includes an ultrasonic oscillator and a waterproof fan. A water inlet and an air outlet are formed in the ultrasonic oscillator, and the water mist discharged from the air outlet is sent to the plasma activated droplet generation device by the waterproof fan.

Preferably, an air-cooled semiconductor plane refrigerator is provided as the refrigeration device.

Preferably, the fresh food preservation equipment further includes a water storage tank mounted on the preservation box, the water storage tank is connected with the atomization device through a water pipe, and a valve is arranged on the water pipe.

Preferably, a food tray is arranged on a side wall of the cavity.

Compared with the prior art, the present disclosure achieves the following technical effects.

In the present disclosure, the water mist provided by the atomization device is ionized by the plasma activated droplet generation device, resulting in various active material beams such as O₃, H⁺, O₂⁻, O, H, NO, OH⁻ and NOONH, and the active material beams are in omni-directional contact with fresh food, so that the effects of sterilization and preservation are effectively achieved. The refrigeration device is used to reduce the temperature inside the cavity so as to reduce the respiration intensity of fresh food. The atomization device is used to increase the humidity inside the cavity and keeping the fresh food moist. Therefore, the fresh food preservation equipment in the present disclosure achieves the effects of keeping moisture and reducing the respiration intensity of fruits and vegetables while keeping fresh, and the quality of fresh food can be effectively ensured, so that the shelf life is prolonged.

### BRIEF DESCRIPTION OF THE DRAWINGS

To more clearly illustrate the technical solutions in the embodiments of the present disclosure or the prior art, the following briefly introduces the attached figures to be used in the embodiments. Apparently, the attached figures in the following description show merely some embodiments of the present disclosure, and those skilled in the art may still obtain other drawings from these attached figures without creative efforts.

FIG. 1 is a structural schematic diagram of a fresh food preservation equipment according to an embodiment of the present disclosure.

FIG. 2 is a structural schematic diagram of a plasma activated droplet generation device.

Reference signs in the attached figures: 1, water inlet; 2, water storage tank; 3, valve; 4, atomization device; 5, plasma activated droplet generation device; 6, high-voltage and high-frequency alternating current power supply; 7, voltage-adjustable direct current power supply; 8, waterproof fan; 9, cooling fan; 10, first insulating cover; 11, refrigeration device; 12, silicone elbow; 13, metal electrode; and 14, second insulating cover.

### DETAILED DESCRIPTION OF THE EMBODIMENTS

The following clearly and completely describes the technical solutions in the embodiments of the present disclosure with reference to the attached drawings of the embodiments of the present disclosure. Apparently, the described embodiments are merely a part rather than all of the embodiments of the present disclosure. Based on the embodiments in the present disclosure, all other embodiments obtained by those skilled in the art under the premise of without contributing creative labor fall within the scope protection of the present disclosure.

An objective of the present disclosure is to provide a fresh food preservation equipment. The equipment achieves the effects of keeping moisture and reducing the respiration intensity of fruits and vegetables while keeping fresh, and the quality of fresh food is effectively ensured, so that the shelf life is prolonged.

To make the above objective, features and advantages of the present disclosure clearer and easier to understand, the present disclosure is further described in detail below with reference to the attached figures and specific embodiments.

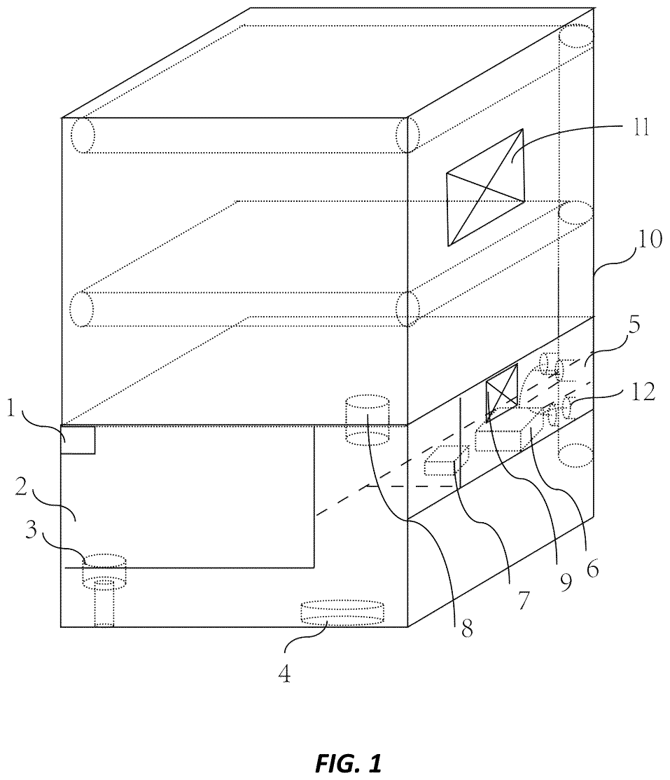

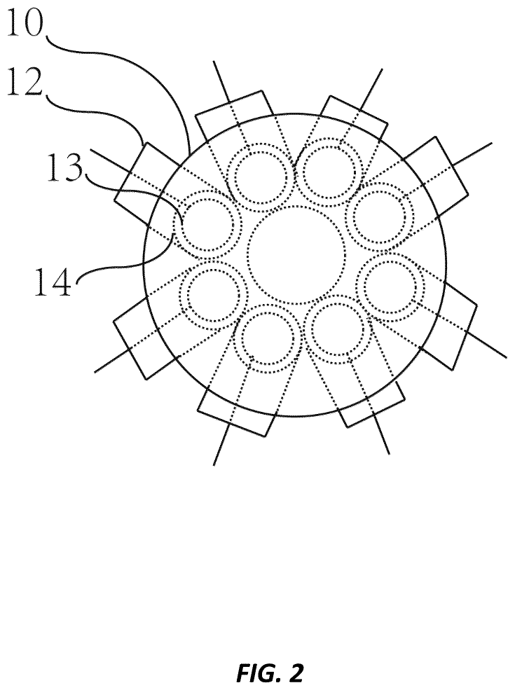

Referring to FIG. 1 and FIG. 2, this embodiment provides a fresh food preservation equipment. The fresh food preservation equipment includes a preservation box, an atomization device 4, a plasma activated droplet generation device 5, a refrigeration device 11, a sensing system, and a control unit.

The fresh-keeping box body is formed with a cavity therein, and fresh food is placed in the cavity for storage. The atomization device 4 is mounted on the preservation box for outputting water mist to the plasma activated droplet generation device 5. The plasma activated droplet generation device 5 is mounted on the preservation box for ionizing the water mist output from the atomization device 4 and feeding the resulting activated mist into the cavity. The refrigeration device 11 is mounted on the preservation box for reducing temperature inside the cavity. The sensing system includes an oxygen sensor, a humidity sensor, and a temperature sensor for monitoring oxygen concentration, temperature, and humidity in the cavity, respectively. The control unit is electrically connected with the atomization device 4, the plasma activated droplet generation device 5, the refrigeration device 11, and the sensing system, respectively, for controlling operation of the plasma activated droplet generation device 5 according to oxygen concentration information returned by the oxygen sensor, controlling operation of the atomization device 4 according to humidity information returned by the humidity sensor, and controlling operation of the refrigeration device 11 according to temperature information returned by the temperature sensor.

The working principle of the fresh food preservation equipment according to this embodiment is as follows.

The water mist provided by the atomization device 4 is ionized by the plasma activated droplet generation device 5, resulting in various active material beams such as O₃, H⁺, O₂⁻, O, H, NO, OH⁻ and NOONH, and the active material beams are in omni-directional contact with fresh food, so that the effects of sterilization and preservation are effectively achieved. In addition, when the oxygen concentration information returned by the oxygen sensor is higher than a preset value of the control unit, oxygen in the cavity can be consumed by the plasma activated droplet generation device 5, so that the oxygen concentration is reduced. The refrigeration device 11 is used to reduce the temperature inside the cavity so as to reduce the respiration intensity of fresh food. The atomization device 4 is used to increase the internal humidity of the cavity and keeping the fresh food moist. Therefore, the fresh food preservation equipment in the present disclosure achieves the effects of keeping moisture and reducing the respiration intensity of fruits and vegetables while keeping fresh, and the quality of fresh food can be effectively ensured, so that the shelf life is prolonged.

As a possible example, in this embodiment, the plasma activated droplet generation device 5 includes a first insulating cover 10, second insulating covers 14, metal electrodes 13, and wires. The first insulating cover 10 is sleeved outside the second insulating covers 14 to form water mist flow channels between the first insulating cover 10 and the second insulating covers 14. The metal electrodes 13 are arranged inside the second insulating covers 14, and the metal electrodes are electrically connected with the wires. The wires are connected to a power supply. Multiple second insulating covers 14 are arranged in the first insulating cover 10, so that the metal electrodes 13 in adjacent second insulating covers 14 are capable of discharging with each other, and the water mist in the water mist flow channel is ionized, resulting in activated mist. The first insulating cover 10 communicates with the atomization device 4 through a polyvinyl chloride tube, an air outlet is formed in the first insulating cover 10, and the second insulating covers 14 are arranged in a sealed manner. The water mist outputted from the atomization device 4 enters the first insulating cover 10, ionized by the plasma activated droplet generation device 5 when passing through adjacent ionization activation areas of the multiple second insulating covers 14, and then enters the cavity through the air outlet. Since the second insulating covers 14 are arranged in a sealed manner, and the wires are connected with the power supply outside the first insulating cover 10 through the silicone elbows 12, so that the water mist cannot make contact with the metal electrodes 13 inside the second insulating covers 14, avoiding a short circuit. The wires pass through the silicone elbows 12. The silicone elbows 12 are fixed to the second insulating covers 14 for guiding the wires. The above wires can be direct current silicone high-voltage wires with a cross-sectional area of 1.5 mm² and an outer diameter of 4.9 mm, and can withstand a maximum voltage of 30 kV.

As a possible example, in this embodiment, both the first insulating cover 10 and the second insulating covers 14 are in a cylindrical shape. Taking an axis of the first insulating cover as a center of the plasma activated droplet generation device, multiple second insulating covers 14 are arranged along a circumferential direction of the plasma activated droplet generation device without interval. Since the second insulating covers 14 are in a cylindrical shape, the atmospheric breakdown spacing is significantly shortened, the energy consumption is reduced, and the activation effect is enhanced. The second insulating covers 14 are arranged along the circumferential direction of the plasma activated droplet generation device without interval (namely, two adjacent second insulating covers 14 abut against each other), so that the utilization of the space inside the first insulating cover 10 is effectively increased.

As a possible example, in this embodiment, the metal electrodes 13 are in a cylindrical shape and are concentrically arranged with the second insulating covers 14. According to different actual needs, metal electrodes 13 of other shapes can also be selected by those skilled in the art.

As a possible example, referring to FIG. 2, in this embodiment, a PVC (polyvinyl chloride) tube is provided as the first insulating cover 10, and quartz glass tubes are provided as the second insulating covers 14. A nylon tube is arranged on an inner side of the multiple second insulating covers 14 that are arranged along the circumferential direction of the plasma activated droplet generation device, and the nylon tube is concentrically arranged with the first insulating cover 10. The nylon tube is fixedly connected with the first insulating cover 10 through a connector. The second insulating covers 14 are sandwiched between an outer side of the nylon tube and an inner side of the first insulating cover 10 so as to fix positions of the second insulating covers 14 with each other.

In this embodiment, each of the second insulating covers 14 has an inner diameter of 8 mm, a wall thickness of less than 2 mm, and a length of 10 cm. The first insulating cover 10 has an outer diameter of 5 cm. The nylon connector has a thickness of 1.5 mm and an outer diameter of 15 mm. Each of the silicone elbows has a length of 4 cm.

As a possible example, in this embodiment, the atomization device 4 includes an ultrasonic oscillator and a waterproof fan 8. The water mist produced by the ultrasonic oscillator is sent into the first insulating cover 10 of the plasma activated droplet generation device 5 by the waterproof fan 8.

Referring to FIG. 1, in this embodiment, the first insulating cover 10 includes a vertical section and an annular section, and the vertical section communicates with the annular section. Multiple annular sections are arranged horizontally, and are different in height. The second insulating covers 14 that are arranged in the circumferential direction of the plasma activated droplet generation device without interval are located in the vertical section. By providing multiple annular sections, the active material beams provided by the plasma activated droplet generation device 5 can be more uniformly distributed in the cavity of the preservation box.

In this embodiment, the fresh food preservation equipment further includes a water storage tank 2. The water storage tank 2 is mounted on the preservation box. The water storage tank 2 is connected with the atomization device 4 through a water pipe. A valve 3 is arranged on the water pipe. A water inlet 1 is formed in the preservation box, and the water inlet 1 communicates with the water storage tank 2.

Specifically, in this embodiment, the atomization device 4 has a working power of 25 W, and a single-core atomization plate is contained therein. An atomization head is made of stainless steel, and the maximum mist yield is 300 mL/h. The atomization device 4 has a function of automatic water cut-off protection. When the water supply level at the water inlet sensed by a water level sensor of the atomization device 4 is lower than a preset water level, the atomization head of the atomization device 4 shuts off automatically.

As a possible example, in this embodiment, an air-cooled semiconductor plane refrigerator is provided as the refrigeration device 11. The air-cooled semiconductor plane refrigerator is configured with a thermocouple pair connected by P-type and N-type semiconductor materials, which forms a cold end and a hot end when current passing through. Heat is taken away by a fan in heat sinks at the hot end, and cold air is blown out by a cooling fan at the cold end. According to different actual needs, other types of refrigeration devices 11 can also be selected by those skilled in the art.

As a possible example, in this embodiment, the preservation box includes an inner box, an outer box, an insulating layer, and a box cover. The outer box is sleeved outside the inner box, and the insulating layer is filled between the inner box and the outer box. Openings are formed in tops or sides of the inner box and the outer box, and the box cover is mounted at the position of the openings, so that the preservation box can be opened or closed. A food tray is arranged on a side wall of the cavity, and the atomization device 4 is located below the food tray. A movable clamp plate is detachably mounted on the inner box, and the movable clamp plate is located above the food tray, so that fresh food is clamped between the food tray and the movable clamp plate, and the position of fresh food is limited. Air holes are formed in the food tray to facilitate air flow and water drainage. Air holes are also formed in the movable clamp plate to facilitate air flow. The food tray and the movable clamp plate can be made of food-grade polypropylene.

As a possible example, in this embodiment, the fresh food preservation equipment further includes a high-voltage and high-frequency alternating current power supply 6 and a voltage-adjustable direct current power supply 7. The high-voltage and high-frequency alternating current power supply 6 is used for supplying power to the plasma activated droplet generation device 5, with input voltage of 220 V to 230 V, frequency of 50 Hz or 60 Hz, input power of 10 W to 150 W, output voltage of 3000 V to 5000 V, and output frequency of 19 kHz to 59 kHz. The voltage-adjustable direct current power supply 7 is used for supplying power to the atomization device 4, the refrigeration device 11, the sensing system, and the control unit, with input voltage of 220 V, and frequency of 50 Hz or 60 Hz.

As a possible example, in this embodiment, the humidity measurement range of the humidity sensor is 0 to 100%. A probe of the humidity sensor is made of polyethylene, with the characteristics of waterproof and dustproof. The oxygen sensor may be a fluorescent oxygen sensor, and the measurement range of oxygen concentration is 0 to 25%. The probe of the temperature sensor is encapsulated in stainless steel, and the measurement range thereof is −10° C. to 85° C.

In order to prove the preservation effect of the fresh food preservation equipment according to this embodiment, the following experimental data are provided at present.

The color and taste of strawberries have started to change after being left at room temperature for 1-2 days, and the strawberries can be stored at low temperature in a refrigerator for about one week. It can be seen that the shelf life of strawberries is very short, so strawberries are used for preservation experiments in this embodiment.

The experimental materials and methods are as follows:
Step 1. Dandong beauty cream strawberries, purchased in the same batch, fresh without mechanical damage, with uniform color and size, average weight of 22 g per strawberry, and maturity of about 90% is selected.
Step 2. The fresh strawberries are laid flat in a preservation box and placed in a refrigerator as a cold storage control group.
Step 3. The fresh food preservation equipment is set to operate in P mode for 15 min every 2 hours every day, and at the rest of time, the fresh food preservation equipment is set to operate in M mode, and the temperature is set to be 4° C.
Step 4. The microorganism, texture and appearance of the strawberry samples are analyzed during storage.
Step 5. In microbiological analysis, the total bacterial count of the strawberry samples is analyzed according to Microbiological Examination of Food Hygiene-Detection of Aerobic Bacterial Count GB 4789.2-2022. Specifically, five strawberries taken from each group every 24 hours are added into a 0.85% sodium chloride solution at 1:10 and placed on a slap homogenizer to be beaten at a constant speed for 90 s, dilution is carried out with an appropriate gradient, an appropriate dilution degree is selected, 1 mL of a diluent is absorbed, 15-20 mL of soy casein agar is added for mixing. A culture medium has been cultured at 35° C. to 37° C. for 46 h to 50 h, and the total bacterial count is calculated.
Step 6. In texture analysis, the parameters of a puncture experiment are set as follows: the type of the probe is P/2; the reply distance is 20 mm, and the movement speed of the probe before, during and after the test is 2 mm/s. The equatorial peaks of the strawberries are measured. Each of the strawberries is cut into two halves to measure two points. Four points are measured each time in each group. The data of the four points are averaged.

### Results and Analysis are as Follows.

As shown in Table 1, the total bacterial count of the strawberries has been increased from 3.86 CFU/g to 5.3 CFU/g in 2 days under common cold storage conditions. After the strawberries are treated by the fresh food preservation equipment, the total bacterial count of the strawberries is decreased from 3.86 CFU/g to 2.90 CFU/g after 2 days of storage, with a drop of nearly 90%. It shows that through the fresh food preservation equipment, the microorganisms on surfaces of the strawberries can be effectively removed.

TABLE 1
Total bacterial count of the strawberries
during storage under different treatments

| | Common cold | Plasma activated droplet |
|---|---|---|
| Days | storage (unit: CFU/g) | treatment (unit: CFU/g) |
| 0 | 3.86 ± 0.08 | 3.86 ± 0.08 |
| 1 | 4.88 ± 0.02 | 3.19 ± 0.06 |
| 2 | 5.33 ± 0.03 | 2.90 ± 0.10 |
| 3 | 4.96 ± 0.02 | 3.96 ± 0.02 |
| 4 | 5.24 ± 0.01 | 3.52 ± 0.04 |
| 5 | 4.17 ± 0.10 | 2.80 ± 0.15 |
| 6 | 4.05 ± 0.02 | 2.26 ± 0.30 |

As shown in Table 2, the hardness of the strawberries has been decreased from 126.4 g to 80.31 g in 6 days under common cold storage conditions, with a drop of 36.5%. Strawberries are constantly attacked and infected by external germs during storage, and the reproductive speed of the microorganisms is high. Fruit cells breathe vigorously, which is more conducive to microbial reproduction. The nutrients of the fruits are degraded rapidly, so the fruits are gradually softened. However, after the strawberries are treated by the fresh food preservation equipment, the hardness of the strawberries is decreased to 93.6 g after 6 days of storage, with a drop of only 25.9%. It indicates that through the fresh food preservation equipment, the deterioration of the strawberries can be effectively delayed, and the texture characteristics of the strawberries can be maintained to a certain extent.

TABLE 2
Changes in the hardness of the strawberries
during storage under different treatments

| | Common cold | Plasma activated droplet |
|---|---|---|
| Days | storage (unit: g) | treatment (unit: g) |
| 0 | 156.52 ± 29.82 | 156.52 ± 29.82 |
| 1 | 98.10 ± 20.08 | 118.65 ± 25.04 |
| 2 | 105.50 ± 34.38 | 129.13 ± 30.44 |
| 3 | 111.53 ± 16.48 | 132.47 ± 38.73 |
| 4 | 94.04 ± 7.31 | 100.65 ± 20.35 |
| 5 | 92.03 ± 8.36 | 103.43 ± 20.02 |
| 6 | 93.63 ± 19.62 | 123.60 ± 13.06 |

Under common cold storage conditions, the color of the strawberries has changed obviously after 7 days, and obvious white colonyies can be observed on the surfaces of most strawberries after 12 and 19 days, and the strawberries have turned black. However, after the strawberries are treated by the fresh food preservation equipment, most strawberries still maintain a good shape and almost all strawberries are free of bacteria on the surfaces after 19 days. It shows that the preservation effect is good in the latter.

Specific examples are used for illustration of the principles and implementations of the present disclosure. The description of the above-mentioned embodiments is used to help illustrate the method and the core principles of the present disclosure; and meanwhile, those skilled in the art can make various modifications in terms of specific embodiments and scope of application in accordance with the teachings of the present disclosure. In summary, the contents of this specification should not be understood as the limitation of the present disclosure.

What is claimed is:

1. A fresh food preservation equipment, comprising:
a preservation box formed with a cavity therein;
an atomization device mounted on the preservation box for outputting water mist;
a plasma activated droplet generation device mounted on the preservation box for ionizing the water mist output from the atomization device and feeding a resultant activated mist into the cavity;
a refrigeration device mounted on the preservation box for reducing temperature inside the cavity;
a sensing system comprising an oxygen sensor, a humidity sensor, and a temperature sensor for monitoring oxygen concentration, temperature, and humidity in the cavity, respectively; and
a control unit electrically connected with the atomization device, the plasma activated droplet generation device, the refrigeration device, and the sensing system, respectively, for controlling operation of the plasma activated droplet generation device according to oxygen concentration information returned by the oxygen sensor, controlling operation of the atomization device according to humidity information returned by the humidity sensor, and controlling operation of the refrigeration device according to temperature information returned by the temperature sensor.

2. The fresh food preservation equipment according to claim 1, wherein the plasma activated droplet generation device comprises a first insulating cover, second insulating covers, metal electrodes, silicone elbows, and wires; the first insulating cover is sleeved outside the second insulating covers to form water mist flow channels between the first insulating cover and the second insulating covers; the metal electrodes are arranged inside second insulating covers, and the metal electrodes are electrically connected with the wires; the wires are connected to a power supply, and the wires passes through the silicone elbows; the silicone elbows are fixed on the second insulating covers; wherein, a plurality of second insulating covers are arranged in the first insulating cover, so that the metal electrodes in adjacent second insulating covers are capable of discharging with each other, and the water mist in the water mist flow channels is ionized, resulting in the activated mist; the first insulating cover communicates with the atomization device, an air outlet is formed in the first insulating cover, and the second insulating covers are arranged in a sealed manner.

3. The fresh food preservation equipment according to claim 2, wherein the first insulating cover and the second insulating covers are in a cylindrical shape; and taking an axis of the first insulating cover as a center of the plasma activated droplet generation device, the plurality of second insulating covers are arranged along a circumferential direction of the plasma activated droplet generation device without interval.

4. The fresh food preservation equipment according to claim 3, wherein the metal electrodes are in a cylindrical shape and are concentrically arranged with the second insulating covers.

5. The fresh food preservation equipment according to claim 4, wherein a PVC (polyvinyl chloride) tube is provided as the first insulating cover, and quartz glass tubes are provided as the second insulating covers; A nylon tube is arranged on an inner side of the plurality of second insulating covers that are arranged along the circumferential direction of the plasma activated droplet generation device without interval, and the nylon tube is concentrically arranged with the first insulating cover; the nylon tube is fixedly connected with the first insulating cover through a connector, and the second insulating covers are sandwiched between an outer side of the nylon tube and an inner side of the first insulating cover.

6. The fresh food preservation equipment according to claim 1, wherein the atomization device comprises an ultrasonic oscillator and a waterproof fan; a water inlet and an air outlet are formed in the ultrasonic oscillator, and the water mist discharged from the air outlet is sent to the plasma activated droplet generation device by the waterproof fan.

7. The fresh food preservation equipment according to claim 1, wherein an air-cooled semiconductor plane refrigerator is provided as the refrigeration device.

8. The fresh food preservation equipment according to claim 1, wherein the fresh food preservation equipment further comprises a water storage tank mounted on the preservation box, the water storage tank is connected with the atomization device through a water pipe, and a valve is arranged on the water pipe.

9. The fresh food preservation equipment according to claim 1, wherein a food tray is arranged on a side wall of the cavity.
